(19) United States
(12) Patent Application Publication
(10) Pub. No.: US 2021/0060957 A1
(43) Pub. Date: Mar. 4, 2021

(54) LID FOR WASTE LIQUID TANK, WASTE LIQUID COLLECTION DEVICE, AND LIQUID DISCHARGE APPARATUS

(71) Applicant: Masashi Ohnishi, Kanagawa (JP)

(72) Inventor: Masashi Ohnishi, Kanagawa (JP)

(73) Assignee: Ricoh Company, Ltd., Tokyo (JP)

(21) Appl. No.: 16/999,398

(22) Filed: Aug. 21, 2020

(30) Foreign Application Priority Data
Aug. 29, 2019 (JP) 2019-157374
Jun. 27, 2020 (JP) 2020-111002

(51) Int. Cl. B41J 2/17; B41J 2/165

(52) U.S. Cl. CPC B41J 2/1721; B41J 2002/1728; B41J 2/16523

(57) ABSTRACT

A lid covers a waste liquid intake portion of a waste liquid tank that collects a waste liquid. The lid includes an inside opening portion and a communication path portion. The inside opening portion has a first opening to face an interior of the waste liquid tank. The communication path portion to connect the inside opening portion to the atmosphere. The communication path portion has a second opening communicating with the inside opening portion. The first opening is larger in area than the second opening.

### CROSS-REFERENCE TO RELATED APPLICATIONS

This patent application is based on and claims priority pursuant to 35 U.S.C. § 119(a) to Japanese Patent Application Nos. 2019-157374, filed on Aug. 29, 2019 and 2020-111002, filed on Jun. 27, 2020, in the Japan Patent Office, the entire disclosure of each of which is hereby incorporated by reference herein.

### BACKGROUND

### Technical Field

The present disclosure relates to a lid for a waste liquid tank, a waste liquid collection device, and a liquid discharge apparatus.

### Description of the Related Art

A certain printer as a liquid discharge apparatus performs dummy discharge for maintenance of a liquid discharge head. In the dummy discharge (e.g., flushing and purge), the printer discharges a liquid that does not contribute to the printing, thereby generating a waste liquid.

### SUMMARY

Embodiments of the present disclosure describe an improved lid that covers a waste liquid intake portion of a waste liquid tank that collects a waste liquid. The lid includes an inside opening portion and a communication path portion. The inside opening portion has a first opening to face an interior of the waste liquid tank. The communication path portion to connect the inside opening portion to the atmosphere. The communication path portion has a second opening communicating with the inside opening portion. The first opening is larger in area than the second opening.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a side view of a waste liquid collection device according to a first embodiment of the present disclosure;

FIG. 2 is an enlarged side view of a portion of the waste liquid collection device in FIG. 1 when a swing member of the waste liquid collection device is at a standby position;

FIG. 3 is an enlarged side view of the portion of the waste liquid collection device in FIG. 1 when the swing member is at a coupling position;

FIG. 4 is a schematic cross-sectional view of a lid according to the first embodiment of the present disclosure;

FIG. 5 is a schematic plan view of the lid illustrated in FIG. 4;

FIG. 6 is a schematic cross-sectional view of a lid according to a second embodiment of the present disclosure;

FIG. 7 is a schematic plan view of the lid illustrated in FIG. 6;

FIG. 8 is a schematic cross-sectional view of a lid according to a third embodiment of the present disclosure;

FIG. 9 is a schematic plan view of the lid illustrated in FIG. 8;

FIG. 10 is a schematic cross-sectional view of a lid according to a fourth embodiment of the present disclosure;

FIG. 11 is a schematic plan view of the lid illustrated in FIG. 10;

FIG. 12 is a schematic cross-sectional view of a lid according to a fifth embodiment of the present disclosure;

FIG. 13 is a schematic plan view of the lid illustrated in FIG. 12;

FIG. 14 is a schematic cross-sectional view of a lid according to a sixth embodiment of the present disclosure;

FIG. 15 is a schematic cross-sectional view of a lid according to a seventh embodiment of the present disclosure;

FIG. 16 is a schematic cross-sectional view of a lid according to an eighth embodiment of the present disclosure;

FIG. 17 is a schematic view of a liquid discharge apparatus according to embodiments of the present disclosure; and

FIG. 18 is a plan view of an example of a head unit of the liquid discharge apparatus illustrated in FIG. 17.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

Embodiments of the present disclosure are described below, with reference to the accompanying drawings.

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

There is known a waste liquid collection tank that includes a tank body and a lid to cover an opening portion of the tank body. The lid includes a waste liquid introduction port and an atmosphere communication port.

With such a configuration, a waste liquid introduced through the lid may scatter. Accordingly, the waste liquid may adhere to the atmosphere communication port and solidify, resulting in clogging of the atmosphere communication port. Therefore, the waste liquid may not be normally collected in the waste liquid collection tank. In this case, if the atmosphere communication port is enlarged, the collected waste liquid may be dried and solidified in the waste liquid collection tank.

The present disclosure has been made in view of the above-described situation and aims to enable the waste liquid to be collected stably.

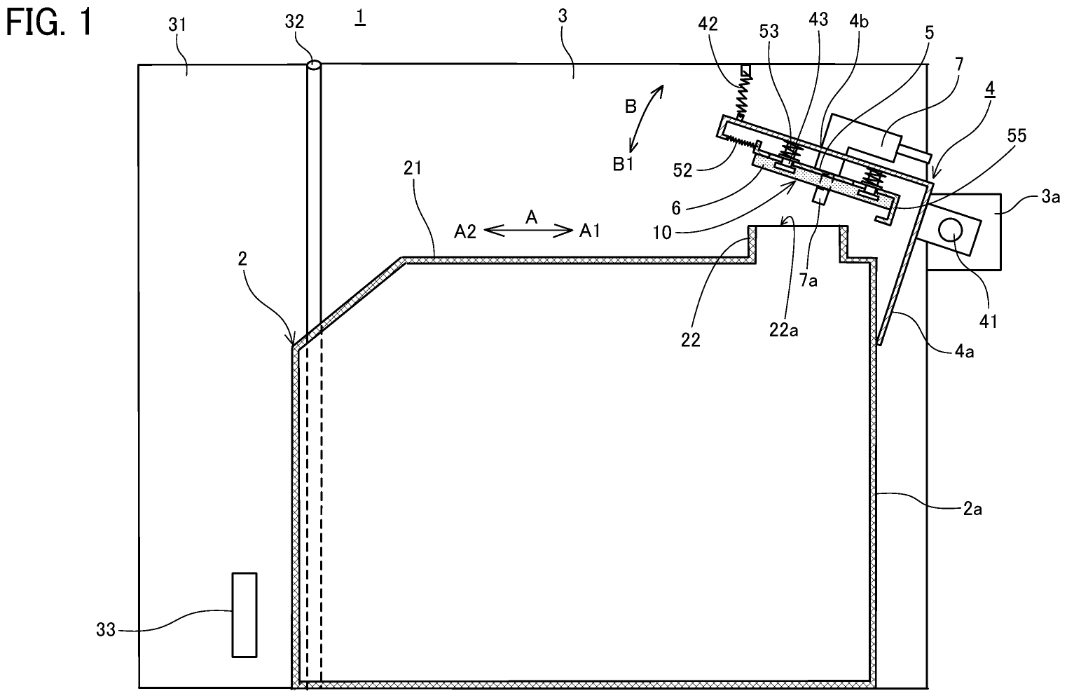

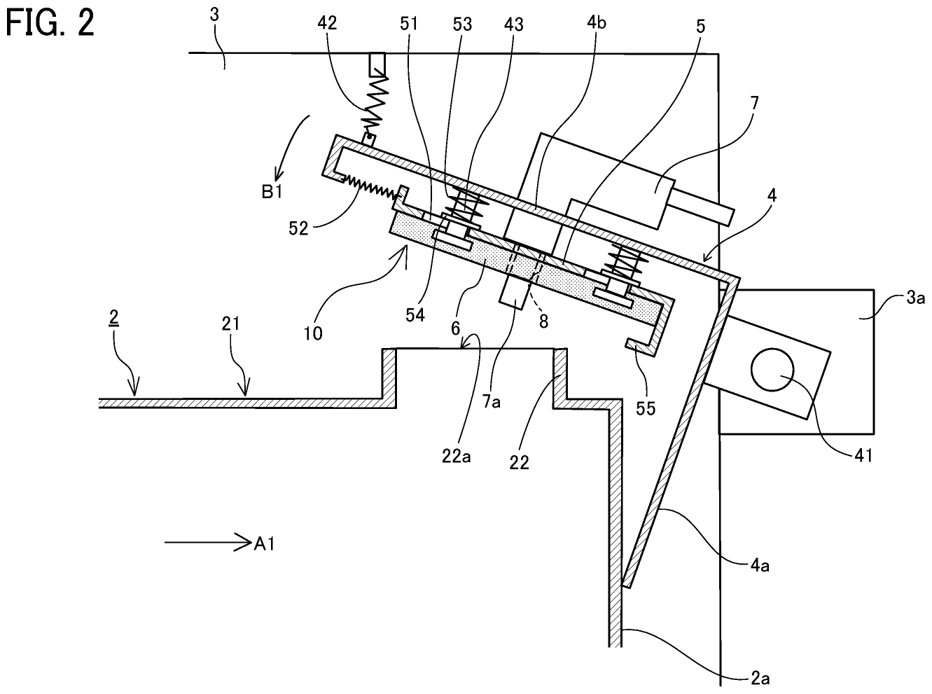

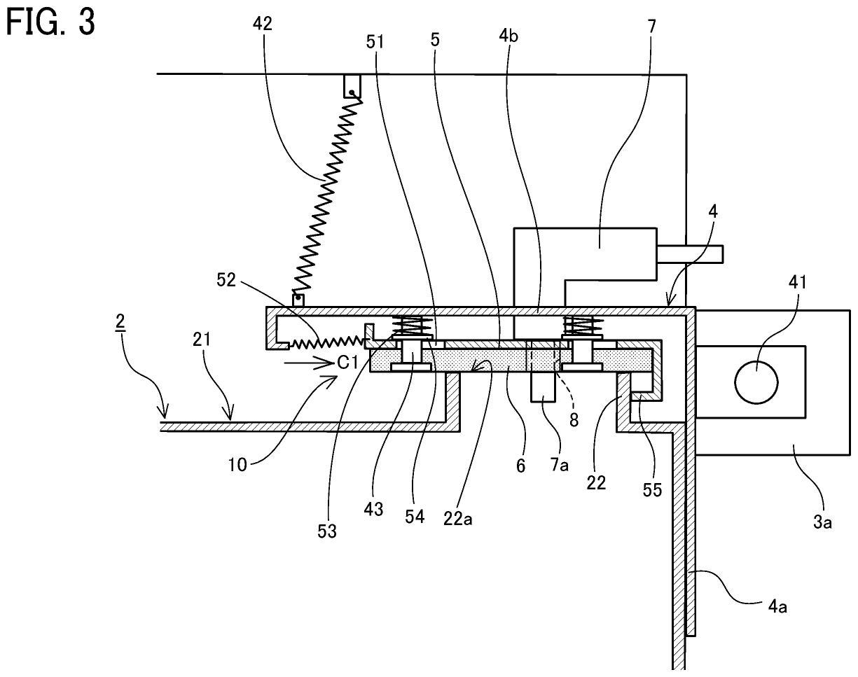

A first embodiment of the present disclosure is described with reference to FIGS. 1 to 5. FIG. 1 is a side view of a waste liquid collection device 1 according to the first embodiment. FIG. 2 is an enlarged side view of a portion of the waste liquid collection device 1 when a swing member of the waste liquid collection device 1 is at a standby position. FIG. 3 is an enlarged side view of the portion of the waste liquid collection device 1 when the swing member is at a coupling position.

The waste liquid collection device 1 includes a tank mount 3 in which a waste liquid tank 2 as a waste liquid container to store a waste liquid is removably installable. The waste liquid tank 2 includes a tank body 21 to store the waste liquid and a waste liquid intake portion 22 projecting from the tank body 21. The waste liquid intake portion 22 has a waste liquid intake 22a communicating with the interior of the tank body 21. The waste liquid tank 2 is removably insertable into the tank mount 3 in the direction indicated by arrow A. The insertion direction is indicated by arrow A1, and the removal direction is indicated by arrow A2.

In the tank mount 3, a swing lever 4 as a swing member is swingably disposed on the rear side of the tank mount 3 (i.e., the end in the insertion direction) in the insertion and removal direction of the waste liquid tank 2 indicated by arrow A. As indicated by arrow B, the swing lever 4 is swingably supported around a shaft 41 by a support 3a of the tank mount 3, and is swingable between the standby position illustrated in FIGS. 1 and 2 and the coupling position illustrated in FIG. 3. In the coupling position, a waste liquid discharge port 7a faces the waste liquid intake 22a of the waste liquid tank 2 to discharge a waste liquid.

The swing lever 4 is formed by bending a flat plate and includes an engagement portion 4a and a holding portion 4b. The engagement portion 4a is pushed by a front face 2a of the waste liquid tank 2, and the holding portion 4b intersects the engagement portion 4a at a substantially right angle. A biasing member 42 biases the swing lever 4 to the standby position illustrated in FIG. 2. The biasing member 42 such as a coil spring is disposed between the tank mount 3 and the end of the holding portion 4b on the side opposite the shaft 41.

The holding portion 4b of the swing lever 4 holds a lid 10 as a capping member to cover the waste liquid intake portion 22 of the waste liquid tank 2. The lid 10 is movable (slidable) back and forth along the holding portion 4b in the in-plane direction of the lid 10. The lid 10 includes a seal 6 as a contact component and a slider 5 as a holder. The seal 6 contacts the waste liquid intake portion 22 of the waste liquid tank 2 to cover the waste liquid intake portion 22. The slider 5 is slidable back and forth along the holding portion 4b of the swing lever 4 in the in-plane direction and serves as the holder to hold the seal 6. The holding portion 4b of the swing lever 4 includes four guide shafts 43, and the slider 5 has guide slots 51. The guide shafts 43 movably fit into the guide slots 51, so that the slider 5 is slidable and movable back and forth together with the seal 6 with respect to the holding portion 4b of the swing lever 4.

A biasing member 52 such as a tension coil spring biases the slider 5 to the initial position illustrated in FIG. 2. The biasing member 52 is disposed between the front end of the swing lever 4 and the end of the slider 5. When the waste liquid tank 2 is removed from the tank mount 3, the biasing member 52 biases the lid 10 to the upper left in FIG. 2 and holds the lid 10 at the initial position in FIG. 2. Further, the slider 5 includes a contact portion 55. When the waste liquid tank 2 is inserted in the insertion direction indicated by arrow A1, the waste liquid intake portion 22 of the waste liquid tank 2 contacts and presses the contact portion 55.

Biasing members 53 such as compression coil springs fit on the guide shafts 43 between the slider 5 of the lid 10 and the holding portion 4b of the swing lever 4. With this configuration, the slider 5 is movable back and forth together with the seal 6 with respect to the holding portion 4b. As illustrated in FIG. 3, when the seal 6 of the lid 10 contacts the waste liquid intake portion 22 of the waste liquid tank 2, the biasing members 53 press the seal 6 against the waste liquid intake portion 22 with biasing force (resilience). Holding members 54 (see FIG. 3) supports the ends on the slider 5 side of the biasing members 53 that press (bias) the seal 6 against the waste liquid intake portion 22. With this configuration, the ends on the slider 5 side of the biasing members 53 are movable relative to the slider 5, thereby preventing the biasing members 53 from twisting.

The slider 5 holds a waste liquid discharge portion 7 including the waste liquid discharge port 7a that penetrates a through hole 8 of the seal 6. The waste liquid is discharged from the waste liquid discharge port 7a. The waste liquid discharge portion 7 penetrates the swing lever 4 so as to move along with the slider 5.

The seal 6 is preferably made of, but is not limited to, a material such as a plastic sheet having high smoothness and a low friction coefficient. The seal 6 contacts the entire area of the upper end of the waste liquid intake portion 22 to seal the waste liquid intake 22a. Alternatively, the seal 6 may cover the entire waste liquid intake 22a with a certain gap between the upper end and the seal 6.

As illustrated in FIG. 1, the waste liquid collection device 1 includes a door 31 on the front side in the insertion direction of the waste liquid tank 2 indicated by arrow A1. The door 31 is swingable around a rotation shaft 32, and a projection 33 is disposed on the inside face of the door 31 to press the waste liquid tank 2 toward the rear side in the insertion direction. The projection 33 inhibits biasing force of the biasing members 42 and 52 of the swing lever 4 from pushing back the waste liquid tank 2 in the removal direction indicated by arrow A2 after the waste liquid tank 2 has been inserted into the waste liquid collection device 1.

In the waste liquid collection device 1, when the waste liquid tank 2 is installed in the tank mount 3, the waste liquid tank 2 is inserted in the insertion direction indicated by arrow A1 in FIG. 1, causing the front face 2a of the waste liquid tank 2 to contact the engagement portion 4a of the swing lever 4 as illustrated in FIGS. 1 and 2. From this state, as the waste liquid tank 2 is further pushed in the insertion direction indicated by arrow A1, the engagement portion 4a of the swing lever 4 is pushed by the waste liquid tank 2, and the swing lever 4 swings in the direction indicated by arrow B1 in FIGS. 1 and 2 against the resilience of the biasing member 42.

Then, as the waste liquid tank 2 is yet further pushed in the insertion direction indicated by arrow A1, the waste liquid intake portion 22 of the waste liquid tank 2 contacts the contact portion 55 of the slider 5 of the lid 10. From this state, as the waste liquid tank 2 is still further pushed in the insertion direction indicated by arrow A1, the swing lever 4 further swings in the direction indicated by arrow B 1. At the same time, the waste liquid intake portion 22 pushes the slider 5, so that the slider 5 of the lid 10 moves (slides) together with the seal 6 in the direction indicated by arrow Cl as illustrated in FIG. 3.

At this time, although the seal 6 contacts the waste liquid intake portion 22 of the waste liquid tank 2, the slider 5 slides with respect to the swing lever 4. Therefore, when the waste liquid tank 2 is pushed in the direction indicated by arrow A1, the swing lever 4 can swing in the direction indicated by arrow B1 while the relative position between the seal 6 and the waste liquid intake portion 22 of the waste liquid tank 2 is substantially maintained. Then, as the waste liquid tank 2 is furthermore pushed in the insertion direction indicated by arrow A1, as illustrated in FIG. 3, the swing lever 4 further swings in the direction indicated by arrow B1, and the seal 6 is pressed against the waste liquid intake portion 22 of the waste liquid tank 2. As a result, the seal 6 seals (caps) the waste liquid intake portion 22.

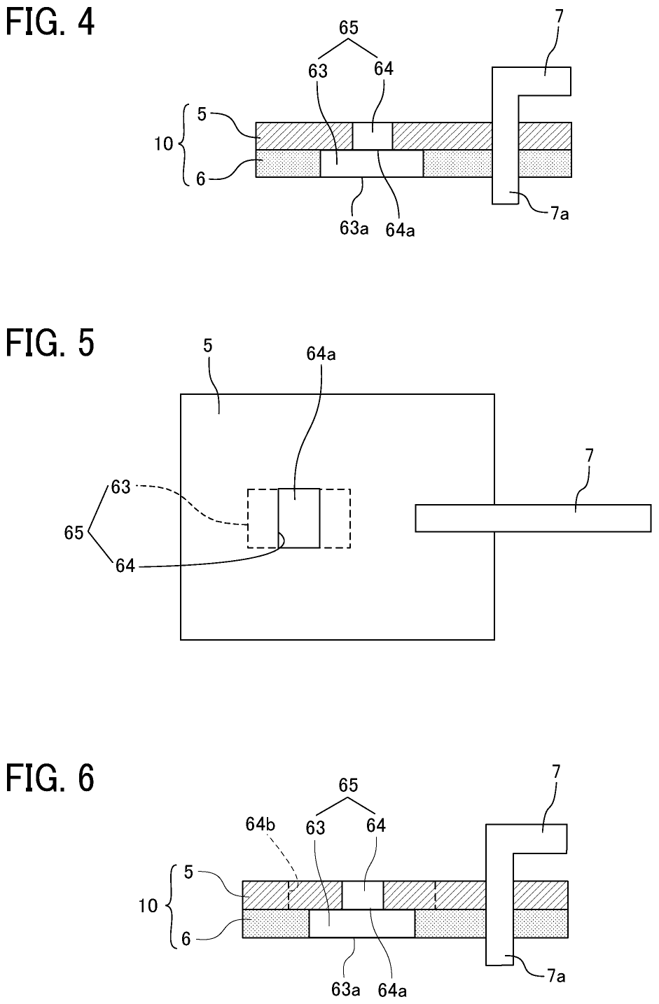

Next, the lid 10 according to the first embodiment of the present disclosure is described with reference to FIGS. 4 and 5. FIG. 4 is a cross-sectional view of the lid 10. FIG. 5 is a plan view of the lid 10. As described above, the lid 10 includes the seal 6 that contacts the waste liquid intake portion 22 of the waste liquid tank 2 and the slider 5 serving as the holder to hold the seal 6.

In the present embodiment, the seal 6 includes an inside opening portion 63 to face the interior of the waste liquid tank 2, and the slider 5 includes a communication path portion 64 to connect the inside opening portion 63 to the atmosphere. In the lid 10, the inside opening portion 63 and the communication path portion 64 construct an atmosphere communication passage 65 to connects the interior of the waste liquid tank 2 to the atmosphere. An opening 63a of the inside opening portion 63 that faces the interior of the waste liquid tank 2 is larger in area than an opening 64a of the communication path portion 64 communicating with the inside opening portion 63.

This configuration prevents the atmosphere communication passage 65 from being clogged with a scattered waste liquid that adheres to the wall surface of the atmosphere communication passage 65 and solidifies on the wall surface even when the waste liquid discharged from the waste liquid discharge port 7a scatters. The minimum opening area of the atmosphere communication passage 65 is the area of the opening 64a of the communication path portion 64, and the inside opening portion 63 has the large opening 63a, thereby preventing the collected waste liquid from being dried and solidified.

As described above, the waste liquid is stably discharged because the atmosphere communication passage 65 is not clogged, and the collected waste liquid is prevented from solidifying in the waste liquid tank 2. Therefore, the waste liquid is stably collected in the waste liquid tank 2.

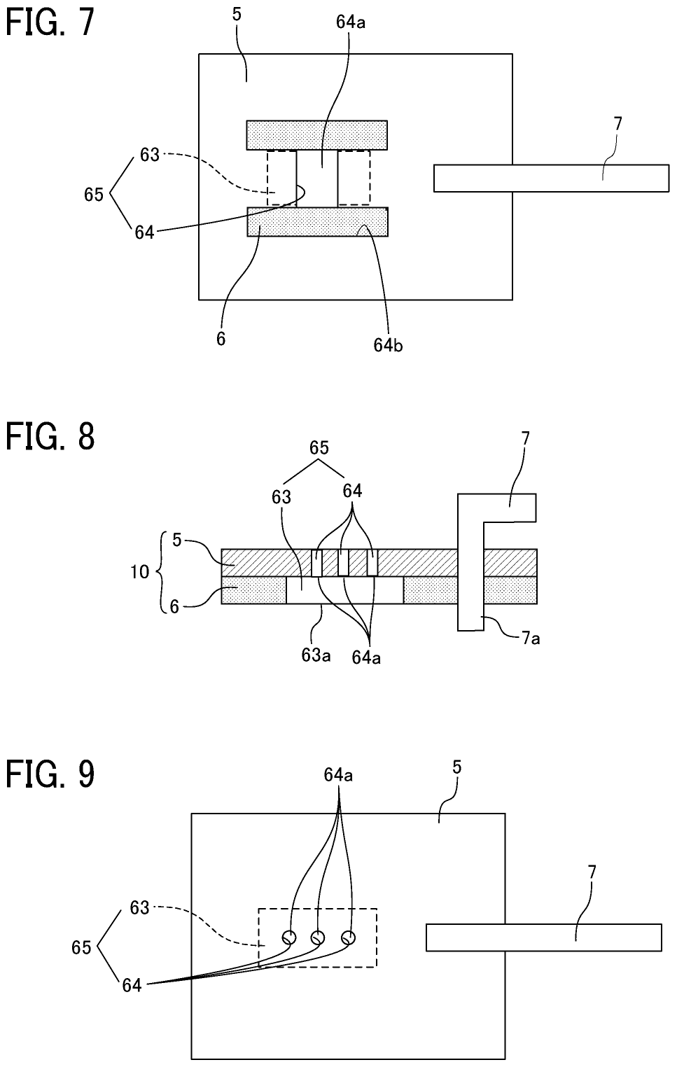

Next, a lid 10 according to a second embodiment of the present disclosure is described with reference to FIGS. 6 and 7. FIG. 6 is a cross-sectional view of the lid 10. FIG. 7 is a plan view of the lid 10. In the present embodiment, the slider 5 includes the communication path portion 64, and an opening 64b on the side opposite the inside opening portion 63 or the opening 64a (i.e., the side that faces outside when the lid 10 covers the waste liquid intake portion 22) of the communication path portion 64 is larger in area than the opening 63a of the inside opening portion 63.

In this case, the area other than the opening 64a of the communication path portion 64 is closed by the seal 6. Therefore, the opening 63a of the inside opening portion 63 that faces the interior of the waste liquid tank 2 is larger in area than the opening 64a of the communication path portion 64 communicating with the inside opening portion 63. That is, similarly to the first embodiment, the minimum opening area of the atmosphere communication passage 65 is the area of the opening 64a of the communication path portion 64 communicating with the inside opening portion 63, thereby obtaining the same functional effect as a functional effect of the first embodiment.

Next, a lid 10 according to a third embodiment of the present disclosure is described with reference to FIGS. 8 and 9. FIG. 8 is a cross-sectional view of the lid 10. FIG. 9 is a plan view of the lid 10. The slider 5 includes a plurality of communication path portions 64 (in the present embodiment, three communication path portions 64). In this case, the area of the opening 63a of the inside opening portion 63 that faces the interior of the waste liquid tank 2 is larger than the total area of the openings 64a of the three communication path portions 64 communicating with the inside opening portion 63. The communication path portion 64 can have a mesh structure. With such a configuration in FIG. 8, the lid 10 according to the third embodiment can obtain the same functional effect as the functional effect of the first embodiment.

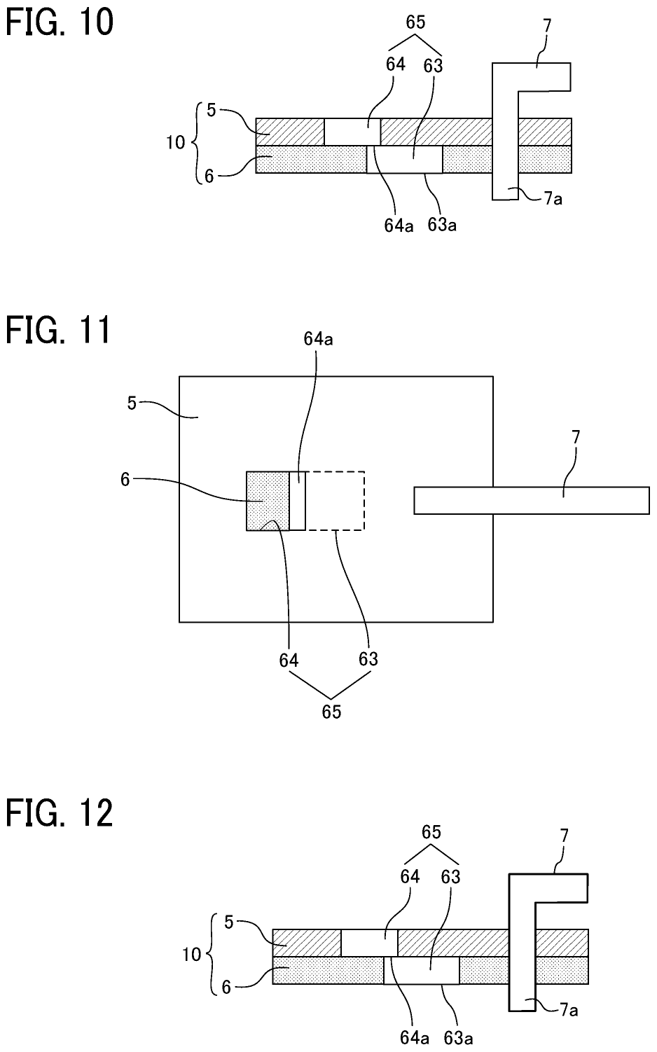

Next, a lid 10 according to a fourth embodiment of the present disclosure is described with reference to FIGS. 10 and 11. FIG. 10 is a cross-sectional view of the lid 10. FIG. 11 is a plan view of the lid 10. In the present embodiment, the inside opening portion 63 of the seal 6 and the communication path portion 64 of the slider 5 are disposed in the different positions in the in-plane direction of the lid 10, and a part of the communication path portion 64 is overlapped with the inside opening portion 63. In this case, the overlapped portion of the inside opening portion 63 and the communication path portion 64 is the opening 64a of the communication path portion 64 facing the inside opening portion 63. Therefore, with this configuration, the opening 63a of the inside opening portion 63 that faces the interior of the waste liquid tank 2 is larger in area than the opening 64a of the communication path portion 64 communicating with the inside opening portion 63.

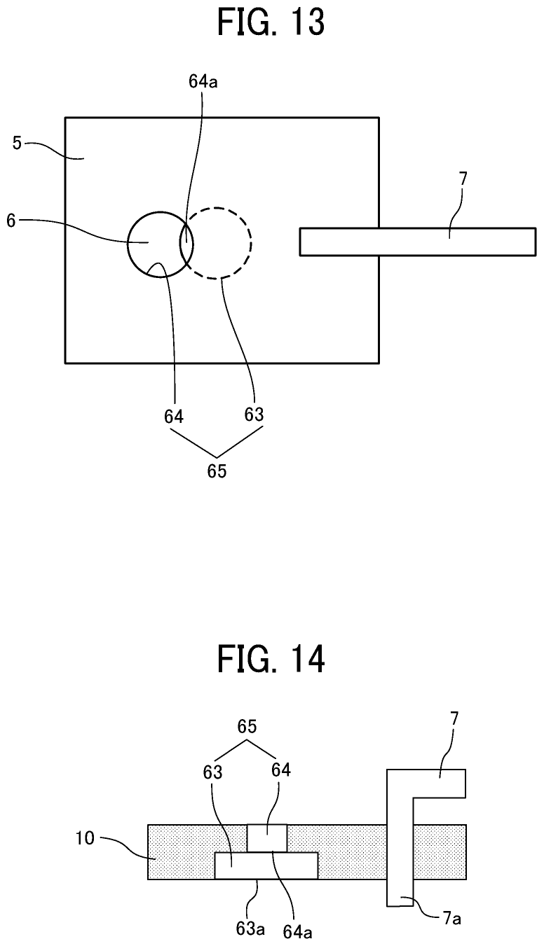

Next, a lid 10 according to a fifth embodiment of the present disclosure is described with reference to FIGS. 12 and 13. FIG. 12 is a cross-sectional view of the lid 10. FIG. 13 is a plan view of the lid 10. In the present embodiment, the inside opening portion 63 of the seal 6 and the communication path portion 64 of the slider 5 are disposed in the different positions in the in-plane direction of the lid 10, and a part of the communication path portion 64 is overlapped with the inside opening portion 63. In this case, the overlapped portion of the inside opening portion 63 and the communication path portion 64 is the opening 64a of the communication path portion 64 facing the inside opening portion 63. The inside opening portion 63 and the communication path portion 64 are both circular.

Therefore, with this configuration, the opening 63a of the inside opening portion 63 that faces the interior of the waste liquid tank 2 is larger in area than the opening 64a of the communication path portion 64 communicating with the inside opening portion 63. Further, if the maximum width of the opening 64a in the horizontal direction in FIG. 13 is the same as the width of the opening 64a in the fourth embodiment in the horizontal direction in FIG. 11, the opening 64a in the present embodiment is smaller in area than that in the fourth embodiment. Therefore, in the present embodiment, the waste liquid is further prevented from being dried and solidified as compared with the fourth embodiment.

Next, a lid 10 according to a sixth embodiment of the present disclosure is described with reference to FIG. 14. FIG. 14 is a cross-sectional view of the lid 10. In the present embodiment, a lid 10 is a single-piece component and includes an inside opening portion 63 to face the interior of the waste liquid tank 2 and a communication path portion 64 to connect the inside opening portion 63 to the atmosphere.

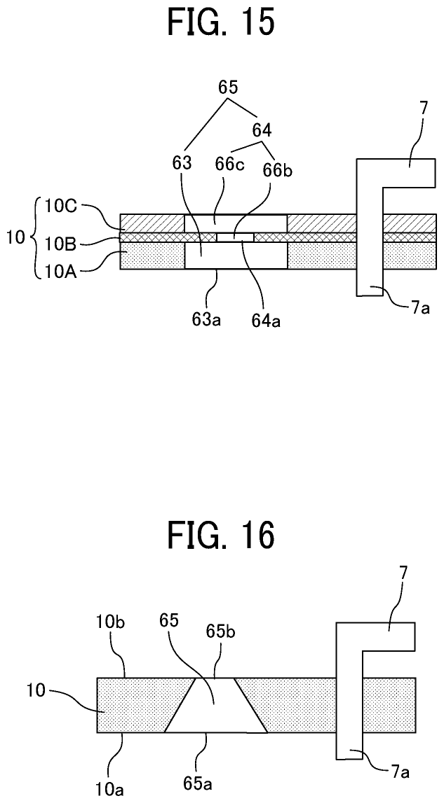

Next, a lid 10 according to a seventh embodiment of the present disclosure is described with reference to FIG. 15. FIG. 15 is a cross-sectional view of the lid 10. In the present embodiment, the lid 10 includes three components 10A to 10C that are layered. The component 10A on the side of the waste liquid tank 2 includes the inside opening portion 63, and the components 10B and 10C have through holes 66b and 66c forming the communication path portion 64. The opening area of the through hole 66b of the component 10B is smaller than the opening area of the inside opening portion 63, and the opening of the through hole 66b facing the inside opening portion 63 is the opening 64a of the communication path portion 64.

Next, a lid 10 according to an eighth embodiment of the present disclosure is described with reference to FIG. 16. FIG. 16 is a cross-sectional view of the lid 10. In the present embodiment, the lid 10 includes the atmosphere communication passage 65 formed of a through hole whose cross-sectional area in the in-plane direction continuously (or stepwise) decreases from a surface 10a that faces the interior of the waste liquid tank 2 to a surface 10b opposite the surface 10a. The lid 10 may include a plurality of components similarly to the first embodiment. In the atmosphere communication passage 65, an inside opening 65a that faces the interior of the waste liquid tank 2 is larger in area than an opening 65b opposite the inside opening 65a. According to such a configuration in FIG. 16, the lid 10 according to the eighth embodiment can obtain the same functional effect as the functional effect of the first embodiment.

Note that the contact component in the above-described embodiments is applicable not only to the waste liquid collection device 1 according to the first embodiment but also to other waste liquid collection devices having a configuration different from the first embodiment.

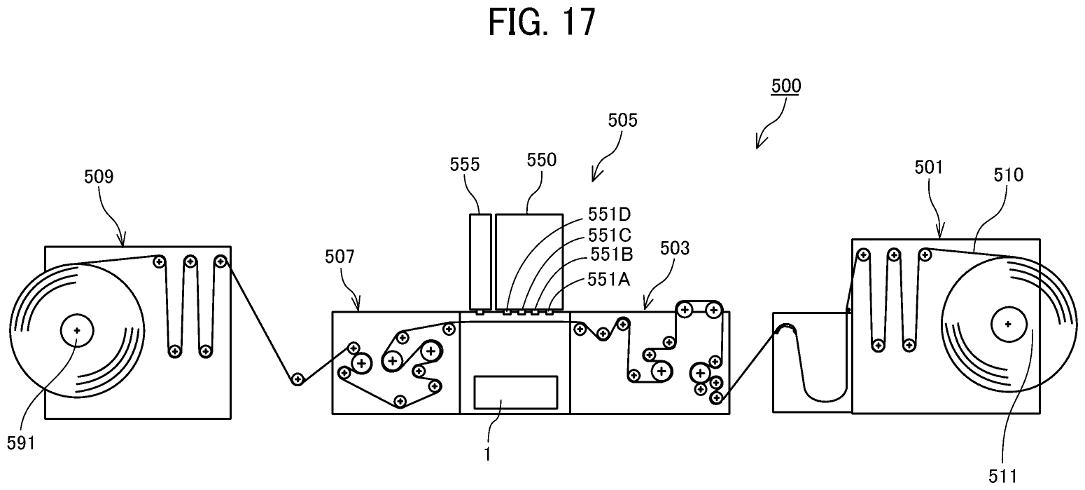

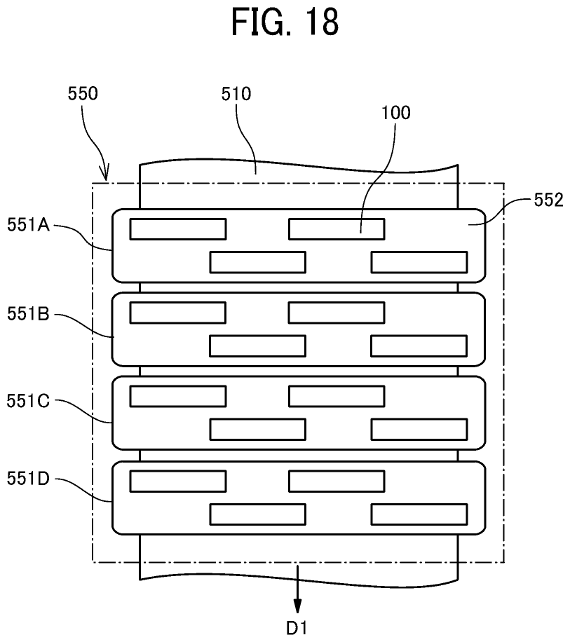

FIGS. 17 and 18 illustrate an example of a liquid discharge apparatus according to embodiments of the present disclosure. FIG. 17 is a schematic view of the liquid discharge apparatus. FIG. 18 is a plan view of a head unit of the liquid discharge apparatus illustrated in FIG. 17. A printer 500 serving as the liquid discharge apparatus includes a feeder 501 to feed a continuous medium 510, such as a rolled paper or web, a guide conveyor 503 to guide and convey the continuous medium 510, fed from the feeder 501, to a printing unit 505, the printing unit 505 to discharge a liquid onto the continuous medium 510 to print an image on the continuous medium 510, a dryer 507 to dry the continuous medium 510, and an ejector 509 to eject the continuous medium 510. The continuous medium 510 is fed from a winding roller 511 of the feeder 501, guided and conveyed with rollers of the feeder 501, the guide conveyor 503, the dryer 507, and the ejector 509, and wound around a take-up roller 591 of the ejector 509.

In the printing unit 505, the continuous medium 510 is conveyed so as to face a head unit 550 and a head unit 555. The head unit 550 discharges the liquid onto the continuous medium 510 to form an image on the continuous medium 510. The head unit 555 discharges a treatment liquid onto the continuous medium 510 to perform post-treatment on the continuous medium 510 with the treatment liquid. Here, the head unit 550 includes, for example, full-line head arrays 551A, 551B, 551C, and 551D for four colors from the upstream side in the conveyance direction of the continuous medium 510 indicated by arrow D1 in FIG. 18. Hereinafter, the full-line head arrays 551A, 551B, 551C, and 551D are simply referred to as the “head array 551” when colors are not distinguished.

Each of the head arrays 551 is a liquid discharge device to discharge a liquid of black (K), cyan (C), magenta (M), or yellow (Y) onto the continuous medium 510 conveyed along the conveyance direction of the continuous medium 510. Note that the number and types of colors are not limited to the above-described four colors of K, C, M, and Y and may be any other suitable number and types. In each head array 551, for example, as illustrated in FIG. 18, liquid discharge heads 100 are disposed in a staggered arrangement on a base 552 to form the head array 551. Note that the configuration of the head array 551 is not limited to such a configuration.

The printing unit 505 includes the waste liquid collection device 1 according to the above embodiments of the present disclosure. As a result, the waste liquid collection device 1 can collect the waste liquid for a long time without clogging the waste liquid discharge port 7a.

The waste liquid collected by the waste liquid collection device 1 includes, for example, a waste liquid of the treatment liquid and a waste liquid of the ink used in dummy discharge for maintenance of the liquid discharge head 100 (e.g., flushing and purge) that does not contribute to the printing of the image.

In the above-described embodiments, the printer 500 is the apparatus that prints on the continuous medium 510. Alternatively, the printer 500 may be an apparatus that prints on a cut sheet.

In the present specification, the terms “image formation”, “recording”, “printing”, “image printing”, and “fabricating” used herein may be used synonymously with each other.

As described above, according to the present disclosure, a waste liquid can be collected stably.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

What is claimed is:

1. A lid configured to cover a waste liquid intake portion of a waste liquid tank that collects a waste liquid, the lid comprising:
an inside opening portion having a first opening configured to face an interior of the waste liquid tank; and
a communication path portion configured to connect the inside opening portion to an atmosphere, the communication path portion having a second opening communicating with the inside opening portion,
the first opening larger in area than the second opening.

2. The lid according to claim 1,
wherein an opening area of the communication path portion is smaller than an opening area of the inside opening portion.

3. The lid according to claim 1,
wherein the communication path portion and the inside opening portion are disposed in different positions in an in-plane direction of the lid, and a part of the communication path portion is overlapped with the inside opening portion.

4. The lid according to claim 1, further comprising:
a contact component configured to contact the waste liquid intake portion, the contact component including the inside opening portion; and
a holder holding the contact component, the holder including the communication path portion.

5. A lid configured to cover a waste liquid intake portion of a waste liquid tank that collects a waste liquid, the lid comprising an atmosphere communication passage configured to connect an interior of the waste liquid tank to an atmosphere,
the atmosphere communication passage having a first opening configured to face an interior of the waste liquid tank and a second opening opposite the first opening,
the first opening larger in area than the second opening.

6. A waste liquid collection device comprising:
the lid according to claim 1;
the waste liquid tank; and
a tank mount in which the waste liquid tank is removably installed.

7. A liquid discharge apparatus comprising:
a printing unit configured to discharge ink for printing an image; and
the lid according to claim 1.

8. The liquid discharge apparatus according to claim 7,
wherein the waste liquid is a part of the ink that does not contribute to the printing of the image.

9. The liquid discharge apparatus according to claim 7,
wherein the waste liquid is a treatment liquid.

10. A liquid discharge apparatus comprising:
a printing unit configured to discharge ink for printing an image; and
the waste liquid collection device according to claim 6.

11. The liquid discharge apparatus according to claim 10,
wherein the waste liquid is a part of the ink that does not contribute to the printing of the image.

12. The liquid discharge apparatus according to claim 10,
wherein the waste liquid is a treatment liquid.
